(19) United States
(12) Patent Application Publication
(10) Pub. No.: US 2026/0054694 A1
(43) Pub. Date: Feb. 26, 2026

(54) WATER SYSTEM FOR VEHICLE

(71) Applicant: JH Innovations, LLC, Foristell, MO (US)

(72) Inventor: Jason R. HAUK, Foristell, MO (US)

(21) Appl. No.: 19/307,439

(22) Filed: Aug. 22, 2025

Related U.S. Application Data
(60) Provisional application No. 63/686,034, filed on Aug. 22, 2024.

(51) Int. Cl. B60S 1/66; B08B 3/02; B60P 3/36

(52) U.S. Cl. CPC B60S 1/66; B08B 3/026; B60P 3/36

(57) ABSTRACT

A water system configured for installation in a vehicle comprises a pressure washer, a de-ionization system configured for de-ionizing water, and a water softener configured for softening water. The de-ionization system is in fluid communication with the pressure washer and configured to supply de-ionized water to the pressure washer. The water softener is in fluid communication with a water tank installed in the vehicle and configured to supply softened water to the water tank. A tee junction in fluid communication with the de-ionization system and the water softener routes an inlet feed of water to each of the de-ionization system and the water softener. The water system may include valves for selectively routing water, water filters for filtering water, and a waterproof tray configured to contain the components within a single compartment of the vehicle.

### CROSS-REFERENCE TO RELATED APPLICATION

This application claims priority to U.S. Provisional Application No. 63/686,034, filed on Aug. 22, 2024, which is hereby incorporated by reference in its entirety.

### FIELD

The present disclosure generally relates to water systems for vehicles, and more particularly to a water system configured for installation in vehicles to provide both softened water for internal use and deionized water for spot-free exterior washing.

### BACKGROUND

Washing and maintaining large vehicles such as motorhomes, recreational vehicles, boats, and similar vessels presents ongoing challenges for vehicle owners. Regular cleaning and maintenance can help extend vehicle life, prevent costly repairs to exterior surfaces, reduce mold formation, and maintain protective seals and gaskets that keep vehicle interiors protected from environmental elements.

Many recreational vehicle parks, campgrounds, and similar facilities impose restrictions on water usage that make it difficult to effectively wash large vehicles. These limitations often force vehicle owners to seek alternative washing solutions, such as commercial truck washes, self-service recreational vehicle wash facilities, or third-party washing services, which is inconvenient and costly.

Water quality also presents challenges for vehicle maintenance and operation. Hard water containing dissolved minerals can cause buildup in plumbing systems, appliances, and fixtures within recreational vehicles. Additionally, mineral-rich water can leave spots and residue on exterior surfaces after washing, reducing the effectiveness of cleaning efforts and potentially affecting the appearance of the vehicle.

### SUMMARY

Aspects of the present disclosure provide an onboard water system for a vehicle that provides both softened water for internal use and deionized water for spot-free exterior washing.

According to an aspect of the present disclosure, a water system configured for installation in a vehicle is provided. The water system comprises a pressure washer. The water system further comprises a deionization system configured for deionizing water, the deionization system in fluid communication with the pressure washer and configured to supply deionized water to the pressure washer. The water system also comprises a water softener configured for softening water, the water softener in fluid communication with a water tank installed in the vehicle and configured to supply softened water to the water tank. The water system comprises a tee junction in fluid communication with the deionization system and the water softener, the tee junction routing an inlet feed of water to each of the deionization system and the water softener.

According to another aspect of the present disclosure, a water system for a vehicle is provided. The water system comprises a pressure washer. The water system further comprises a de-ionization system configured for de-ionizing water, the de-ionization system in fluid communication with the pressure washer and configured to supply de-ionized water to the pressure washer. The water system also comprises a water softener configured for softening water, the water softener in fluid communication with a water tank installed in the vehicle and configured to supply softened water to the water tank. The water system comprises a valve in fluid communication with an inlet feed of water and the water tank, the inlet feed of water supplying water to each of the de-ionization system and the water softener through a tee junction, the valve configured to selectively route water from the inlet feed through the tee junction to the de-ionization system or from the water tank to the de-ionization system.

According to yet another aspect of the present disclosure, a method of installing a water system in a vehicle is provided. The water system comprises a pressure washer, a de-ionization system, and a water softener, the de-ionization system configured for de-ionizing water, the de-ionization system in fluid communication with the pressure washer and configured to supply de-ionized water to the pressure washer, the water softener configured for softening water and supplying softened water to a water tank installed in the vehicle. The method comprises installing a mounting system on a tray. The method comprises mounting the water system on the tray using the mounting system. The method further comprises installing the tray in a compartment of the vehicle and connecting an inlet feed of the water system to a water source. The method also comprises installing a tee junction in fluid communication with the inlet feed to route water to both the de-ionization system and the water softener. Further, the method comprises establishing fluid communication between the de-ionization system and a pressure washer and establishing fluid communication between the water softener and a water tank installed in the vehicle.

Other objects and features of the present invention will be in part apparent and in part pointed out herein.

### BRIEF DESCRIPTION OF THE DRAWINGS

FIG. 1 is a schematic diagram of a water system according to an embodiment.

FIG. 2 illustrates components of the water system of FIG. 1 installed on a tray according to an embodiment.

FIG. 3 illustrates an example application of the water system of FIG. 1 according to an embodiment.

FIG. 4 illustrates components of the water system installed in a vehicle compartment according to an embodiment.

FIG. 5 illustrates a perspective view of the water system installed in a compartment according to an embodiment.

FIG. 6 illustrates a perspective view of a tray and mounting system according to an embodiment.

FIG. 7 illustrates a perspective view of the water system installed in a compartment according to an embodiment.

FIG. 8 is a flowchart of a method for installing the water system in a vehicle according to an embodiment.

Corresponding reference numbers indicate corresponding parts throughout the drawings.

### DETAILED DESCRIPTION

Vehicles such as motorhomes, recreational vehicles, boats, and similar large mobile units present challenges for maintaining cleanliness and water quality during travel and extended use. Traditional washing methods may be limited by water availability, quality restrictions at various locations, and the lack of appropriate facilities for cleaning large vehicles. Additionally, water quality issues such as mineral content and hardness can affect both the vehicle's internal water systems and the effectiveness of exterior cleaning operations.

The present disclosure relates to an integrated water system designed for installation in vehicles such as, but not limited to: motorhomes, recreational vehicles (RVs), and boats. The water system provides dual functionality by processing water for both internal vehicle use and external vehicle use, such as washing applications. The system addresses the challenges faced by vehicle owners who encounter water restrictions at RV parks and campgrounds, while also providing enhanced water quality for onboard consumption and cleaning.

The water system incorporates water treatment technologies that enable spot-free washing capabilities, eliminating water spots and residue that commonly occur during vehicle cleaning operations. The system processes incoming water through multiple treatment stages to produce both softened water for internal vehicle systems and deionized water for external washing applications. This dual-path approach allows vehicle owners to maintain their vehicles without relying on external wash facilities or third-party services.

The compact design of the water system allows installation within a single vehicle compartment, maximizing space efficiency while providing comprehensive water treatment capabilities. The system is configured to operate with city or municipal water connections, for example, through a single quick-connect hose attachment, enabling seamless integration with available water sources. Water passes through the treatment components with ease, providing operational flexibility for users in various camping and travel scenarios.

The water treatment capabilities extend beyond vehicle washing to improve overall water quality for drinking, cooking, and general use within the vehicle. The system addresses calcium buildup issues in pipes, faucets, and shower heads by providing softened water to internal vehicle systems. This approach helps maintain the vehicle's plumbing infrastructure while enhancing the user experience through improved water quality.

The system provides operational flexibility by allowing users to run directly off water sources while maintaining treated water supplies for internal vehicle use. This configuration enables continuous operation without depleting onboard water reserves, while still providing access to treated water when needed. The remote operation capabilities eliminate the need for users to repeatedly return to the system during operation, enhancing convenience and operational efficiency during vehicle cleaning tasks.

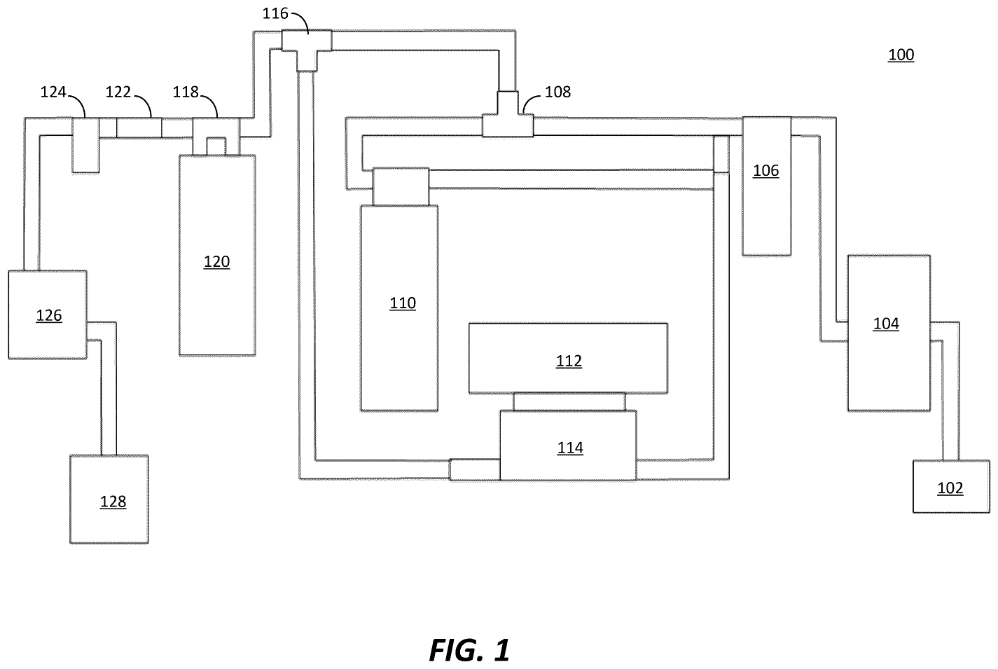

Referring to FIG. 1, a water system in accordance with the present disclosure is generally indicated at reference number 100. The water system 100 is configured for installation in a vehicle and provides integrated water treatment capabilities through multiple processing pathways. The water system 100 incorporates a schematic representation that demonstrates the fluid communication relationships between various components designed to process water for different applications within and around the vehicle. The system configuration enables dual functionality by providing both water softening capabilities for internal vehicle systems and de-ionization capabilities for external washing applications. In some cases, the water system 100 is designed to fit within a single compartment of a motorhome, recreational vehicle, or boat while maintaining operational efficiency across both treatment pathways.

The water system 100 receives water input from a water source 102, which may represent city water connections, campground water supplies, or other external water sources available to vehicle operators. An inlet feed 104 establishes fluid communication between the water source 102 and downstream treatment components within the water system 100. The inlet feed 104 may comprise appropriate hoses, fittings, and connection hardware to facilitate water transfer from the water source 102 into the water system 100. In some cases, the inlet feed 104 may incorporate quick-connect fittings to enable rapid connection and disconnection from various water sources encountered during travel.

The water source 102 may represent various external water supply connections available to vehicle operators during travel and stationary periods. The water source 102 may comprise city water connections at campgrounds, municipal water supplies at RV parks, or other potable water sources encountered during vehicle operation. In some cases, the water source 102 may provide water at varying pressures and quality levels depending on the specific supply infrastructure available at different locations. The water source 102 establishes the primary input for the water system 100 and may be accessed through standardized connection fittings commonly used in recreational vehicle applications.

The inlet feed 104 provides fluid communication between the water source 102 and downstream treatment components within the water system 100. The inlet feed 104 may comprise hoses, spigots, valves, and hardware components that facilitate water transfer from external sources into the treatment system. In some cases, the inlet feed 104 may incorporate quick-connect hose attachments that enable rapid connection to city or other external water sources, for example, allowing water to pass through the system with ease during setup operations. The inlet feed 104 may include appropriate fittings, couplings, and connection hardware designed to accommodate various water source configurations encountered during vehicle travel. The inlet feed 104 may also incorporate shut-off capabilities to control water flow from the water source 102 into the water system 100 during connection and disconnection procedures.

With continued reference to FIG. 1, a water filter 106 is positioned downstream of the inlet feed 104 to provide initial filtration of incoming water before distribution to treatment components. The water filter 106 is configured to remove sediment, chlorine, and other contaminants that could affect the performance of downstream treatment systems. Following the water filter 106, a tee junction 108 routes the inlet feed 104 of water to multiple treatment pathways within the water system 100. The tee junction 108 establishes fluid communication with both de-ionization and water softening components, enabling simultaneous or selective operation of different treatment processes. In some cases, the tee junction 108 may incorporate flow control mechanisms to regulate water distribution between the different treatment pathways.

The tee junction 108 receives filtered water from the water filter 106 and routes the inlet feed 104 of water to multiple treatment pathways within the water system 100. The tee junction 108 establishes fluid communication with both the de-ionization system 120 and the water softener 110, enabling simultaneous or selective distribution of water to different treatment processes. In some cases, the tee junction 108 may incorporate flow control mechanisms or valving arrangements that regulate water distribution between the different treatment pathways based on operational requirements. The tee junction 108 may comprise appropriate fittings and connection hardware that maintain fluid communication while directing water flow to downstream components. The configuration of the tee junction 108 enables the water system 100 to process water through dual treatment paths, with one path directed toward water softening applications and another path directed toward de-ionization applications for external washing operations.

A water softener 110 receives water from the tee junction 108 and is configured for softening water by removing calcium, magnesium, and other minerals that contribute to water hardness. The water softener 110 establishes fluid communication with a water tank 112 installed in the vehicle and is configured to supply softened water to the water tank 112. The water tank 112 represents the vehicle's onboard fresh water storage system, which supplies water to internal vehicle systems including sinks, showers, and appliances. As further shown in FIG. 1, a water heater 114 is positioned downstream of the water tank 112 to provide heated water for various vehicle applications. In one example, the water softener 110 comprises ion exchange resins or other softening media that replace hardness minerals with sodium or potassium ions, producing softened water that reduces scale buildup in vehicle plumbing systems.

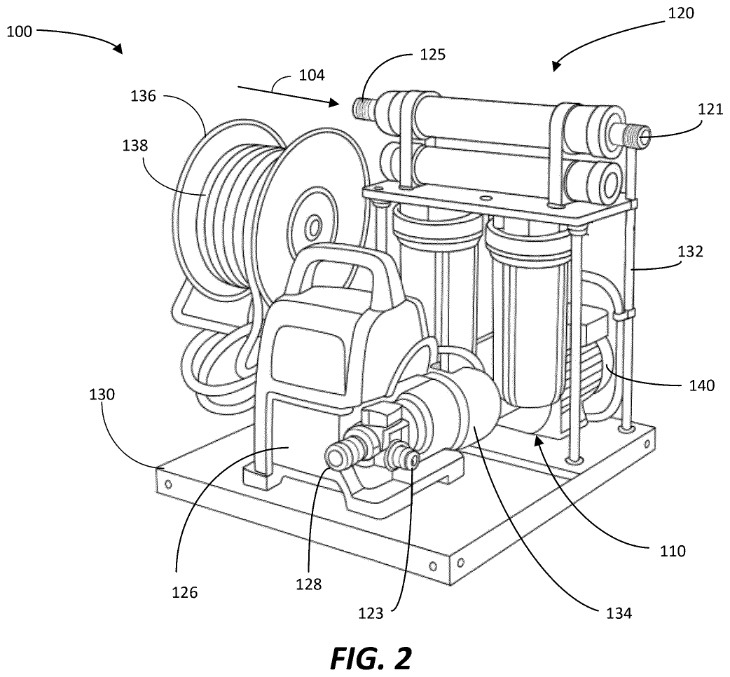

Referring to FIG. 2, the water system 100 incorporates the water softener 110 in a compact arrangement that enables installation within vehicle compartments while maintaining operational accessibility. The water softener 110 establishes fluid communication with the water tank 112 through appropriate piping and connection hardware that facilitates the transfer of softened water to onboard storage systems. A water softener pump 140 is positioned to facilitate water movement through the water softener 110 and downstream components, providing the pressure differential needed to drive water through ion exchange media and associated filtration elements. The water softener pump 140 may operate automatically in response to water demand signals or is controlled manually through system controls that enable operators to manage water treatment cycles based on usage patterns and water quality conditions.

The water tank 112 is configured to receive and store softened water from the water softener 110, providing a reservoir of treated water for internal vehicle systems including plumbing fixtures, appliances, and other water-consuming devices. The water tank 112 may comprise materials and construction methods that maintain water quality during storage periods while preventing contamination or degradation of the softened water. The connection between the water softener 110 and the water tank 112 may incorporate check valves, flow regulators, and other control devices that manage water transfer rates and prevent backflow conditions that could compromise system operation. In some cases, the water tank 112 may include level sensors, overflow protection, and other monitoring systems that provide feedback regarding water storage status and system performance.

The water heater 114 is positioned downstream of the water tank 112 to receive softened water for heating applications throughout the vehicle's hot water distribution system. The water heater 114 establishes fluid communication with the water tank 112 through supply lines that deliver softened water to heating elements or heat exchangers within the water heater 114. The configuration enables the water heater 114 to receive pre-treated water that reduces scale formation on heating surfaces, improving heat transfer efficiency and extending equipment service life. In some cases, the water heater 114 may incorporate temperature controls, pressure relief systems, and other safety features that manage heated water delivery while maintaining system integrity during various operating conditions.

The water system 100 incorporates a source/tank valve 116 that provides selective routing of water between different supply sources and treatment pathways. The source/tank valve 116 enables operators to choose between direct water source input or water from the water tank 112 for various system operations. In some cases, the source/tank valve 116 allows the system 100 to operate directly from city water, for example, while maintaining treated water supplies in the water tank 112 for internal vehicle use.

A de-ionization system bypass valve 118 is positioned to control water flow to de-ionization components, enabling selective operation of the de-ionization treatment pathway. The de-ionization system bypass valve 118 allows operators to direct water around de-ionization components when such treatment is not needed for particular applications. With continued reference to FIG. 1, the de-ionization system bypass valve 118 establishes fluid communication with multiple components within the water system 100, including the tee junction 108, the water tank 112, and the de-ionization system 120. The valve configuration enables selective routing of water from the inlet feed 104 through the tee junction 108 to the de-ionization system 120, or alternatively from the water tank 112 to the de-ionization system 120 depending on the desired water source for de-ionization processing. In some cases, the de-ionization system bypass valve 118 may incorporate multiple port configurations that accommodate different flow routing scenarios while maintaining system pressure and flow characteristics throughout various operating modes.

The de-ionization system bypass valve 118 establishes fluid communication pathways that maintain system pressure balance and flow continuity during valve position changes and operational transitions. The valve design may incorporate sealing mechanisms and flow control features that prevent water leakage or pressure loss during switching operations between different water supply sources. In some cases, the de-ionization system bypass valve 118 may include position indicators or feedback mechanisms that provide operators with visual confirmation of the selected flow routing configuration, enabling proper system operation and preventing inadvertent valve positioning that could compromise treatment effectiveness. The valve construction may accommodate the pressure and flow characteristics of both the inlet feed 104 and the water tank 112 supply systems, ensuring consistent performance regardless of the selected water source for de-ionization processing operations.

A de-ionization system 120 is configured for de-ionizing water by removing dissolved ions and minerals to produce high-purity water suitable for spot-free washing applications. The de-ionization system 120 establishes fluid communication with downstream components and is configured to supply de-ionized water for external vehicle washing operations, for example. In some cases, the de-ionization system 120 comprises dual-bed ion exchange configurations that remove both cationic and anionic species from the water. The de-ionization system 120 may incorporate regenerable resins that can be recharged when treatment capacity becomes depleted. Following the de-ionization system 120, a shut-off valve 122 may provide flow control for the de-ionized water pathway, enabling operators to start and stop water flow as needed during washing operations.

In one example, the de-ionization system 120 is configured for de-ionizing water by removing dissolved ionic species that contribute to water spotting and residue formation during vehicle washing operations. The de-ionization system 120 establishes fluid communication with the pressure washer 126 and is configured to supply de-ionized water to the pressure washer 126 for external vehicle cleaning applications. The configuration enables the production of high-purity water that eliminates mineral deposits and ionic contaminants responsible for water spots that commonly appear on vehicle surfaces after conventional washing procedures. The de-ionization system 120 may process water received from the tee junction 108 through ion exchange media that captures both positively and negatively charged dissolved species, producing treated water with substantially reduced total dissolved solids content.

With continued reference to FIG. 1, the de-ionization system 120 may comprise a dual-bed ion exchange configuration that incorporates separate treatment stages for cationic and anionic species removal. The dual-bed configuration may include a cation exchange resin bed that removes positively charged ions such as calcium, magnesium, sodium, and other metal ions from the water stream. Following cation removal, an anion exchange resin bed may capture negatively charged species including chloride, sulfate, carbonate, and other anionic contaminants that contribute to water conductivity and spotting potential. The sequential treatment approach enables comprehensive ion removal while maintaining treatment efficiency across varying water quality conditions encountered at different geographic locations and water sources.

The dual-bed ion exchange configuration of the de-ionization system 120 may incorporate separate resin chambers that allow independent regeneration of cation and anion exchange media when treatment capacity becomes depleted. The cation exchange resin is regenerated using acid solutions that displace accumulated metal ions and restore the exchange capacity of the resin matrix. The anion exchange resin may undergo regeneration using alkaline solutions that remove captured anionic species and prepare the media for continued operation. In some cases, the regeneration process is implemented based on water quality monitoring or treatment volume tracking that indicates when resin capacity approaches depletion levels.

Referring to FIG. 2, the de-ionization system 120 is positioned within the water system 100 to receive water from upstream treatment components while maintaining compact installation requirements for vehicle compartment mounting. The de-ionization system 120 may incorporate flow distribution mechanisms that ensure uniform water contact with ion exchange media throughout the treatment process. The system configuration enables continuous water processing during washing operations while maintaining consistent de-ionization performance across varying flow rates and pressure conditions. The de-ionization system 120 may include monitoring capabilities that track water quality parameters such as conductivity or total dissolved solids to provide feedback regarding treatment effectiveness and regeneration timing.

The fluid communication between the de-ionization system 120 and the pressure washer 126 is established through piping and connection hardware that maintains water purity while delivering treated water at appropriate pressures for washing applications. As shown in FIG. 1, the shut-off valve 122 is positioned downstream of the de-ionization system 120 to provide flow control for the de-ionized water pathway, enabling operators to manage water delivery to the pressure washer 126 during washing operations. The water filter 124 is positioned between the de-ionization system 120 and the pressure washer 126 to provide final filtration that removes any residual particles or contaminants that could affect washing performance or equipment operation.

The shut-off valve 122 is positioned downstream of the de-ionization system 120 to provide precise flow control for the de-ionized water pathway, enabling operators to manage water delivery during vehicle washing operations with enhanced control and efficiency. The shut-off valve 122 establishes fluid communication between the de-ionization system 120 and downstream components while providing the capability to start and stop water flow as needed during various phases of washing procedures. The positioning of the shut-off valve 122 downstream of the de-ionization system 120 enables operators to isolate the treated water pathway when washing operations are not active, preventing unnecessary water flow and maintaining system pressure within the de-ionized water circuit. In some cases, the shut-off valve 122 may incorporate manual actuation mechanisms that allow operators to control water flow through direct manipulation of valve controls, while other configurations may include automated actuation systems that respond to pressure washer operation or remote-control signals.

With continued reference to FIG. 1, the shut-off valve 122 in one example, is configured to handle the flow rates and pressures associated with de-ionized water delivery to the pressure washer 126 while maintaining the purity of the treated water stream. The valve construction may incorporate materials and sealing systems that prevent contamination of the de-ionized water during flow control operations, ensuring that the water quality achieved by the de-ionization system 120 remains intact throughout the delivery process. The shut-off valve 122 may include flow regulation capabilities that enable operators to adjust water delivery rates based on specific washing requirements or pressure washer specifications. The valve configuration may accommodate varying pressure conditions within the de-ionized water pathway while providing reliable shutoff performance that prevents water waste during periods when washing operations are not active.

In FIG. 2, a connection (not shown) is made between the deionization system 120 and pressure washer 126 at a first connection point 121 and a second connection point 123. Furthermore, tee junction 108 may be placed at the connection port 125 and connect to the water softener 110 (not shown) for delivering water from the inlet feed 104 to at least one of the deionization system 120 or water softener 110.

With continued reference to FIG. 1, an additional water filter 124 is positioned downstream of the de-ionization system 120 to provide final filtration of de-ionized water before delivery to washing equipment. The water filter 124 is configured to remove any residual particles or contaminants that could affect washing performance or equipment operation. The water filter 124 is positioned downstream of the de-ionization system 120 and the shut-off valve 122 to provide final filtration of de-ionized water before delivery to the pressure washer 126. The water filter 124 establishes fluid communication between the shut-off valve 122 and the pressure washer 126 while providing additional water treatment that removes any residual particles, contaminants, or debris that could affect washing performance or pressure washer operation. The positioning of the water filter 124 as a second water filter downstream of the de-ionization system 120 enables comprehensive water treatment that combines ion removal with particulate filtration to produce high-quality water for spot-free washing applications. In some cases, the water filter 124 may incorporate fine filtration media that captures particles in the micron range, ensuring that the de-ionized water delivered to the pressure washer 126 meets the purity standards needed for optimal washing results.

In one example, the water filter 124 comprises filtration media selected to complement the ion removal capabilities of the de-ionization system 120 while addressing any remaining water quality concerns that could impact washing effectiveness or equipment performance. The filtration media within the water filter 124 may include activated carbon, sediment filters, or specialized filtration materials that target specific contaminants or particles that may be present in the de-ionized water stream. The water filter 124 may be configured with replaceable filter cartridges or media that enable maintenance and replacement activities without requiring extensive system disassembly or interruption of water system operation. The filter housing of the water filter 124 may incorporate quick-disconnect fittings or threaded connections that facilitate filter replacement procedures while maintaining system integrity and preventing contamination during maintenance activities.

As further shown in FIG. 1, the sequential arrangement of the shut-off valve 122 and the water filter 124 downstream of the de-ionization system 120 creates a comprehensive treatment and control pathway that ensures de-ionized water quality while providing operational flexibility during washing procedures. The shut-off valve 122 enables operators to control water flow timing and duration, while the water filter 124 provides final quality assurance that removes any remaining contaminants that could compromise washing results or pressure washer performance. The combined functionality of the shut-off valve 122 and the water filter 124 may enhance the overall effectiveness of the de-ionized water pathway by providing both flow control and final filtration capabilities that support consistent spot-free washing results. In some cases, the shut-off valve 122 and the water filter 124 may be integrated into a single assembly that combines flow control and filtration functions within a compact package suitable for vehicle compartment installation.

A pressure washer 126 receives de-ionized water from the treatment pathway and is configured to generate high-pressure water streams for vehicle cleaning applications. In other words, the pressure washer 126 establishes fluid communication with the de-ionization system 120 and is configured to receive de-ionized water that enables spot-free washing results. The pressure washer 126 produces high pressure de-ionized water 128 that is delivered through appropriate hoses and spray equipment for external vehicle cleaning operations. In some cases, the pressure washer 126 is electrically powered and incorporates hose reels, remote control systems, and other features that enhance operational convenience during vehicle washing tasks.

As briefly explained above, the pressure washer 126 can be configured as an electrically powered unit that receives de-ionized water from the treatment pathway and generates high-pressure water streams for external vehicle cleaning applications. In this example, the pressure washer 126 incorporates electrical power configurations that enable operation from standard vehicle electrical systems or external power sources commonly available at campgrounds and RV parks. In some cases, the pressure washer 126 is designed to operate on 12-volt DC power systems typical of recreational vehicles, while other configurations may utilize 120-volt AC power connections. The electrical power configuration of the pressure washer 126 enables consistent operation without dependence on engine-driven or manual pumping systems, providing reliable pressure generation for washing operations.

Referring to FIG. 2, a pressure washer pump 134 is integrated with the pressure washer 126 to generate the high-pressure water flow needed for effective vehicle cleaning. The pressure washer pump 134 may comprise positive displacement pumps, centrifugal pumps, or other pump configurations capable of producing pressures suitable for removing dirt, grime, and other contaminants from vehicle surfaces. In some cases, the pressure washer pump 134 may generate pressures ranging from several hundred to several thousand pounds per square inch, depending on the specific cleaning requirements and vehicle surface materials. The pressure washer pump 134 receives de-ionized water from the upstream treatment components and pressurizes the water for delivery through downstream hose and spray systems.

With continued reference to FIG. 2, a pressure washer hose reel 136 is incorporated with the pressure washer 126 to provide organized storage and deployment of washing hoses during operation. The pressure washer hose reel 136 is configured for automatic retraction of a pressure washing hose, enabling convenient hose management without manual winding or coiling operations. The automatic retraction capability of the pressure washer hose reel 136 may utilize spring-loaded mechanisms, motor-driven systems, or other retraction technologies that automatically retrieve the hose when washing operations are completed. In some cases, the pressure washer hose reel 136 may incorporate controlled retraction speeds to prevent damage to the hose or connected spray equipment during the retraction process.

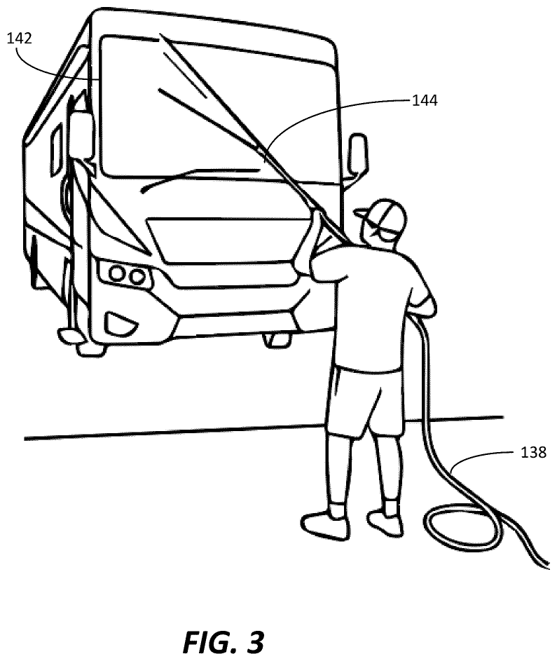

A pressure washer hose 138 extends from the pressure washer hose reel 136 and provides fluid communication between the pressure washer 126 and spray equipment used during vehicle cleaning operations. As shown in FIG. 3, the pressure washer hose 138 is configured with sufficient length to enable operators to reach all areas of a vehicle 142 during washing operations while maintaining connection to the pressure washer 126. The pressure washer hose 138 may comprise high-pressure rated materials capable of withstanding the pressures generated by the pressure washer pump 134 without failure or degradation. In some cases, the pressure washer hose 138 may incorporate reinforcement layers, protective coverings, or other features that enhance durability and operational life under repeated use conditions.

The pressure washer 126 may incorporate a remote-control system (not shown) configured to operate the pressure washer 126 wirelessly, eliminating the need for operators to return to the unit multiple times during washing operations. The remote-control system is configured to enable wireless operation of the pressure washer 126 through radio frequency, infrared, or other wireless communication technologies that provide reliable control over operational distances encountered during vehicle washing. In some cases, the remote-control system may provide start and stop functionality, pressure adjustment capabilities, or other operational controls that enhance convenience during washing operations. The remote-control system may comprise handheld transmitters, wearable devices, or other portable control interfaces that enable operators to maintain control of the pressure washer 126 while positioned at various locations around the vehicle being cleaned.

As further shown in FIG. 3, a pressure washer sprayer 144 is connected to the pressure washer hose 138 and configured to deliver high pressure deionized water 128 to vehicle surfaces during cleaning operations. The pressure washer sprayer 144 may incorporate adjustable spray patterns, flow control mechanisms, or other features that enable operators to customize water delivery for different cleaning applications and surface types. In some cases, the pressure washer sprayer 144 may provide multiple spray configurations including narrow high-pressure streams for stubborn contaminants and wider spray patterns for general washing applications. The pressure washer sprayer 144 receives high pressure de-ionized water 128 from the pressure washer 126 through the pressure washer hose 138, enabling spot-free washing results that eliminate water spots and residue commonly associated with untreated water sources.

The pressure washer 126 may incorporate applicator systems configured for easy application of soap or bug remover during vehicle cleaning operations. These applicator systems may comprise foam generators, chemical injection systems, or other mechanisms that introduce cleaning agents into the water stream delivered through the pressure washer sprayer 144. In some cases, the applicator systems may enable selective application of different cleaning agents depending on the specific cleaning requirements encountered during vehicle washing. The applicator systems may incorporate separate reservoirs, mixing chambers, or other components that maintain cleaning agents in ready-to-use configurations while preventing contamination of the de-ionized water supply. The integration of applicator systems within the pressure washer 126 enables comprehensive vehicle cleaning capabilities while maintaining the spot-free washing benefits provided by the de-ionized water treatment pathway.

Referring to FIG. 2, a tray 130 is configured as a waterproof containment platform that provides a stable mounting base for the water system 100 components within the vehicle installation. The tray 130 is configured to contain the pressure washer 126, the de-ionization system 120, and the water softener 110 within a single compartment of the vehicle, enabling organized arrangement of treatment components while providing protection against water spillage or leakage during operation. The waterproof characteristics of the tray 130 may comprise sealed construction, drainage features, or other containment mechanisms that prevent water from reaching surrounding vehicle structures or compartments. In some cases, the tray 130 may incorporate raised edges, integrated drain systems, or sloped surfaces that direct any spilled water toward collection points or drainage outlets. The tray 130 is constructed from corrosion-resistant materials such as marine-grade aluminum, stainless steel, or reinforced polymers that withstand exposure to water and cleaning chemicals over extended operational periods. In one example, the tray 130 has a width in the range of about 24 inches to about 48 inches and a length in the range of about 24 inches to about 60 inches. In one example, the water system 100 is configured to fit in a compartment with a height in the range of about 20 inches to about 24 inches.

A mounting system 132 is configured for mounting the pressure washer 126, de-ionization system 120, and water softener 110 on the tray 130, providing secure attachment points that maintain component positioning during vehicle movement and operation. As shown in FIG. 2, the mounting system 132 may comprise brackets, clamps, tie-down points, or other fastening mechanisms that accommodate the specific shapes and sizes of different system components. The mounting system 132 is configured to enable modular arrangement of components on the tray 130, allowing for customization based on available space constraints or operational preferences. In some cases, the mounting system 132 may incorporate vibration dampening features, shock absorption mechanisms, or other isolation technologies that protect sensitive components from road vibrations and vehicle movement stresses. The mounting system 132, pressure washer 126, de-ionization system 120, and water softener 110 is shaped and arranged to fit on the tray 130 having specific dimensional constraints that optimize space utilization within vehicle compartments. In one example, the mounting system 132 comprises custom modular brackets that enable flexible installation across multiple vehicle types, supporting a wide range of applications.

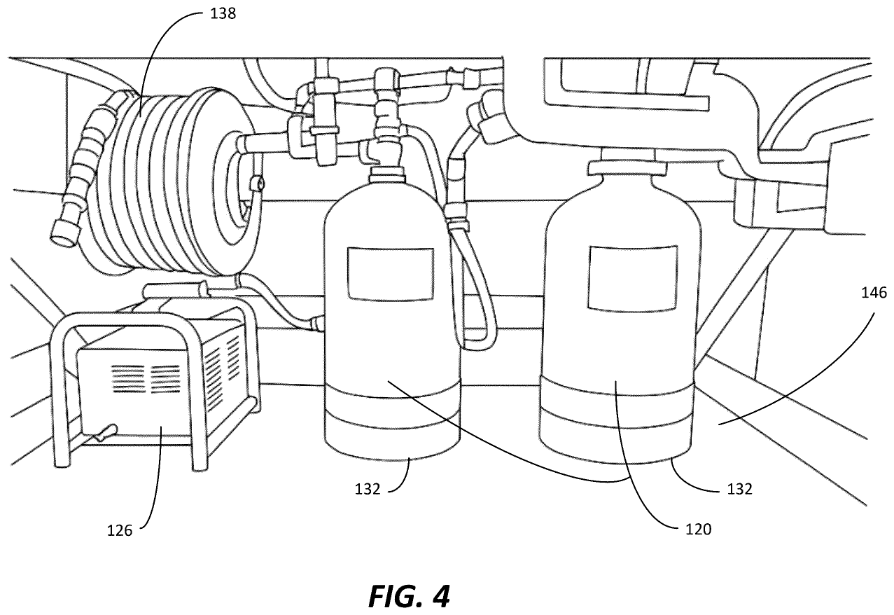

With continued reference to FIG. 2, a compartment 146 may provide the installation space within the vehicle structure where the tray 130 and associated components are positioned during operation and storage. As further shown in FIG. 4, the compartment 146 may comprise existing vehicle storage bays, utility compartments, or dedicated installation spaces that accommodate the water system 100 while maintaining accessibility for operation and maintenance activities. The compartment 146 may incorporate access doors, removable panels, or other opening mechanisms that enable operators to reach system components when needed. In some cases, the compartment 146 may provide environmental protection for the water system 100 components, shielding the treatment equipment from weather exposure, road debris, and other external conditions encountered during vehicle operation. The compartment 146 may incorporate ventilation features, drainage systems, or other environmental controls that maintain appropriate operating conditions for the water treatment components.

The compartment 146 can vary in size and include different wire looms, carriers, and mechanisms depending on the floorplan of the vehicle. The modular design of the water system 100 accommodates this by providing flexibility needed by installers whether on the factory line or in aftermarket settings to adapt seamlessly across multiple vehicle types without compromising functionality or fit.

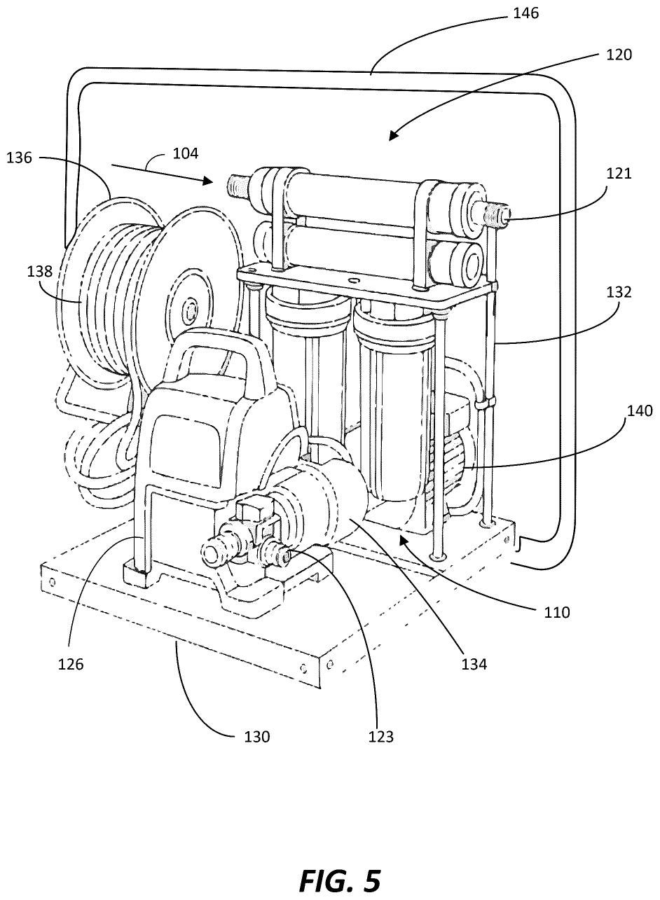

Referring to FIG. 5, the tray 130 is positioned within the compartment 146 in a configuration that maximizes space utilization while maintaining operational accessibility for the mounted components. The arrangement of the pressure washer 126, de-ionization system 120, and water softener 110 on the tray 130 within the compartment 146 enables efficient use of available vehicle space while providing clear access pathways for hose connections, control operations, and maintenance activities. The compartment 146 may provide sufficient clearance around the tray 130 to accommodate component operation, heat dissipation, and service access without interference from surrounding vehicle structures. In some cases, the compartment 146 may incorporate electrical connections, plumbing access points, or other utility interfaces that support the operational requirements of the water system 100 components mounted on the tray 130.

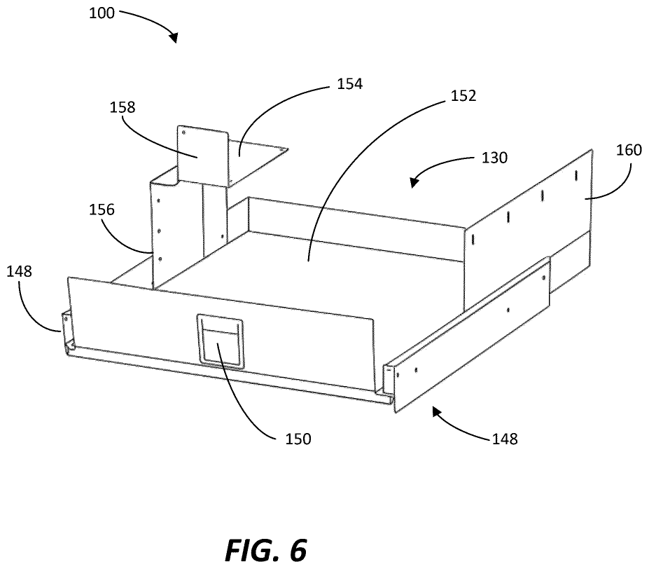

As shown in FIG. 6, a slide assembly 148 is operatively coupled between the compartment 146 and the tray 130, providing translational movement capabilities that enhance accessibility during operation and maintenance activities. The slide assembly 148 is configured to permit translational movement of the tray 130 between a retracted position within the compartment 146 (not shown) and an extended position projecting from the compartment 146 (FIG. 5). The slide assembly 148 may comprise drawer slides, linear bearings, telescoping rails, or other sliding mechanisms that support the weight of the tray 130 and mounted components while enabling smooth movement between positions. In some cases, the slide assembly 148 may incorporate load-bearing capabilities that accommodate the combined weight of the pressure washer 126, de-ionization system 120, water softener 110, and associated mounting hardware without deflection or binding during movement operations. The slide assembly 148 may comprise a slide stop (not shown) configured to limit travel of the tray 130 between the retracted and extended positions, preventing over-extension that could damage components or create unsafe operating conditions.

A handle 150 is integrated with the tray 130 or slide assembly 148 to provide a gripping interface that enables operators to manually control the translational movement of the tray 130 between the retracted and extended positions. The handle 150 is positioned to provide ergonomic access while maintaining clearance from mounted components and associated plumbing connections. In some cases, the handle 150 may comprise multiple grip points, textured surfaces, or other features that enhance operator control during sliding operations. The handle 150 is constructed from materials that provide durability and corrosion resistance while maintaining comfortable grip characteristics under various environmental conditions encountered during vehicle operation.

With continued reference to FIG. 6, the tray 130 may incorporate a multi-level design that maximizes storage capacity and component organization within the available space constraints of the compartment 146. A first level 152 may provide a primary mounting surface for larger components such as the pressure washer 126, while enabling efficient use of vertical space within the compartment 146. A second level 154 is positioned above or adjacent to the first level 152, creating additional mounting or storage areas for smaller components, accessories, or cleaning supplies. The multi-level configuration may enable the water system 100 to accommodate more components and storage capacity than would be possible with a single-level tray design. In some cases, the first level 152 and second level 154 are configured with different load-bearing capabilities, drainage characteristics, or mounting features that optimize their suitability for different types of components or storage applications.

The structural configuration of the tray 130 may incorporate vertical walls that provide containment, organization, and structural support for the multi-level design. A first level first vertical wall 156 may extend upward from the first level 152 to provide lateral containment and structural support for components mounted on the first level 152. A second level vertical wall 158 associated with the second level 154, provides similar containment and support functions for components or materials positioned on the second level 154. A first level second vertical wall 160 may provide additional structural support and containment for the first level 152, creating defined spaces that prevent component movement during vehicle operation. These vertical walls may incorporate mounting points, cable management features, or other organizational elements that enhance the functionality of the multi-level tray design. In some cases, the vertical walls may provide compartmentalization that enables storage of cleaning supplies, spare parts, or other accessories within designated areas of the tray 130, maintaining organization while preventing interference with water treatment components.

The tray 130 is configured to accommodate power units, washers, and tank configurations, allowing for universal installations without the need for welding or structural modifications to the tray.

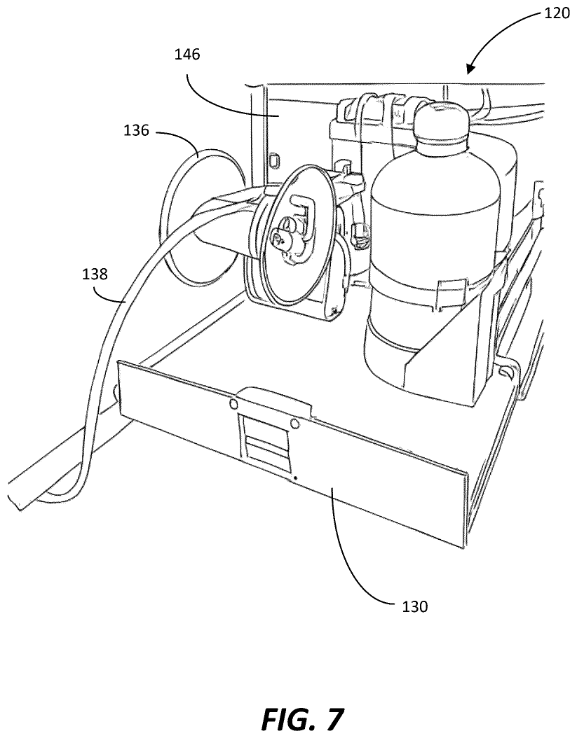

FIG. 7 shows an example of the water system 100 installed on the tray 130 using the mounting system 132. The tray 130 is shown extending from the compartment 146.

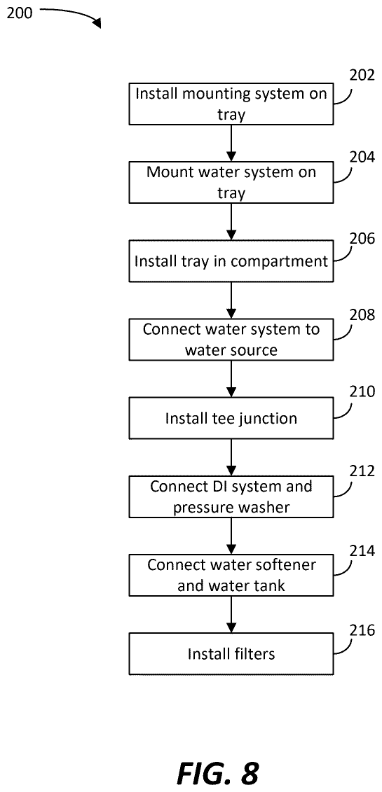

Referring to FIG. 8, a method 200 may provide a systematic approach for installing the water system 100 in the vehicle 142, enabling proper integration of water treatment and pressure washing capabilities within the vehicle compartment 146. The method 200 comprises installation steps that establish both the physical mounting configuration and fluid communication pathways needed for operational functionality. The installation process may begin with foundational mounting procedures and progress through component installation, fluid connections, and system commissioning activities. In some cases, the method 200 is adapted to accommodate different vehicle configurations, compartment dimensions, or component arrangements while maintaining the functional relationships between treatment components.

The method 200 begins at step 202 that involves installing the mounting system 132 on the tray 130 and establishing the foundational attachment points that will secure water treatment components during subsequent installation activities. The step 202 may comprise positioning brackets, clamps, or other fastening mechanisms of the mounting system 132 at predetermined locations on the tray 130 surface. The mounting system 132 installation may involve drilling mounting holes, applying sealants, or other attachment procedures that create secure connection points capable of withstanding operational loads and vehicle movement stresses. In some cases, the step 202 may include verification of mounting point alignment, load distribution characteristics, or clearance requirements that ensure proper component positioning during later installation steps.

Following the mounting system 132 installation, the method 200 proceeds to a step 204 that involves mounting the water system 100 on the tray 130 using the mounting system 132. The step 204 may comprise positioning the pressure washer 126, the de-ionization system 120, and the water softener 110 at their designated locations on the tray 130 and securing these components through the mounting system 132 attachment points. The mounting process may involve aligning component mounting interfaces with the mounting system 132 brackets, inserting fasteners, and applying appropriate torque specifications to achieve secure attachment. In some cases, the step 204 may include routing of electrical connections, preliminary hose positioning, or other preparatory activities that facilitate subsequent installation steps while maintaining component accessibility.

With continued reference to FIG. 8, the method 200 continues with a step 206 that involves installing the tray 130 in the compartment 146 of the vehicle 142, positioning the assembled water treatment components within the designated vehicle installation space. The step 206 may comprise maneuvering the tray 130 and mounted components into the compartment 146 while maintaining clearance from surrounding vehicle structures and utility systems. The installation process may involve connecting the slide assembly 148 between the compartment 146 and the tray 130, enabling translational movement capabilities that enhance operational accessibility. In some cases, the step 206 may include verification of clearance dimensions, drainage alignment, or ventilation requirements that ensure proper environmental conditions for the installed water system 100 components.

The method 200 proceeds to a step 208 that involves connecting the inlet feed 104 of the water system 100 to the water source 102, establishing the primary water supply pathway that enables system operation. The step 208 may comprise installing appropriate hoses, fittings, and connection hardware between external water sources and the inlet feed 104 components. The connection process may involve routing hoses through vehicle access points, installing quick-connect fittings, or other connection mechanisms that enable reliable water transfer from campground supplies, city water systems, or other external sources. In some cases, the step 208 may include pressure testing of connections, leak detection procedures, or flow verification activities that confirm proper water supply functionality before proceeding with downstream installation steps.

As further shown in FIG. 8, the method 200 continues with a step 210 that involves installing the tee junction 108 in fluid communication with the inlet feed 104 to route water to both the de-ionization system 120 and the water softener 110. The step 210 may comprise positioning the tee junction 108 at an appropriate location within the water flow pathway and establishing secure connections to upstream and downstream components. The tee junction 108 installation may involve connecting inlet piping from the inlet feed 104, outlet piping to the de-ionization system 120 pathway, and outlet piping to the water softener 110 pathway. In some cases, the step 210 may include installation of flow control mechanisms, pressure regulation devices, or other flow management components that optimize water distribution between the different treatment pathways.

The method 200 proceeds to a step 212 that involves establishing fluid communication between the de-ionization system 120 and the pressure washer 126, creating the high-purity water pathway that enables spot-free washing capabilities. The step 212 may comprise installing hoses, fittings, and connection hardware that route de-ionized water from the de-ionization system 120 output to the pressure washer 126 input. The fluid communication establishment may involve routing hoses through appropriate pathways, installing intermediate valves or filters, and securing connections to prevent leakage during high-pressure operation. In some cases, the step 212 may include installation of the shut-off valve 122, pressure relief devices, or other safety components that protect system components from excessive pressures or flow conditions.

With continued reference to FIG. 8, the method 200 continues with a step 214 that involves establishing fluid communication between the water softener 110 and the water tank 112 installed in the vehicle 142. The step 214 may comprise connecting the water softener 110 output to the water tank 112 input through appropriate piping, hoses, and connection hardware. The fluid communication establishment may involve routing connections through vehicle structures, installing check valves or flow control devices, and securing connections to prevent contamination or backflow conditions. In some cases, the step 214 may include connection to the water heater 114 or other downstream vehicle water systems that benefit from softened water supply. The step 214 may also involve installation of the source/tank valve 116 that enables selective routing between direct water source input and treated water from the water tank 112.

The method 200 concludes with a step 216 that involves installing filters in the water system 100, providing water treatment capabilities that enhance system performance and protect downstream components from contamination. The step 216 may comprise installing the water filter 106 upstream of the tee junction 108 to filter water from the inlet feed 104 before routing the water through the tee junction 108 to treatment components. The filter installation may also include installing the water filter 124 downstream of the de-ionization system 120 to filter de-ionized water before supplying the de-ionized water to the pressure washer 126. In some cases, the step 216 may involve installing additional filters at other locations within the water system 100, such as filters associated with the water softener 110 pathway or filters positioned to protect specific components from particular contaminants. The filter installation process may include securing filter housings, connecting inlet and outlet piping, and establishing bypass or service connections that facilitate filter replacement during maintenance operations.

The water system 100 provides comprehensive advantages that address the specific challenges faced by motorhome, recreational vehicle, and boat owners who encounter water restrictions and quality issues during travel and camping activities. The system delivers convenience and self-sufficiency benefits by eliminating dependence on external wash facilities, third-party services, and restrictive campground water policies that often limit effective vehicle cleaning operations. Vehicle owners may maintain their investments on their own schedules without coordinating with external service providers or traveling to distant truck wash or self-service facilities. The integrated design enables complete vehicle maintenance capabilities within the confines of the vehicle itself, providing operational independence that enhances the overall travel experience while reducing logistical complications associated with vehicle cleaning requirements.

The system delivers superior water quality and performance through dual treatment pathways that address both internal vehicle systems and external washing applications. The spot-free washing capability eliminates water spots and residue that commonly occur with untreated water sources, producing professional-quality cleaning results without the streaking and mineral deposits associated with conventional washing methods. The deionized water pathway removes dissolved ions and minerals that cause spotting, while the water softening pathway addresses calcium and magnesium content that contributes to scale buildup in vehicle plumbing systems. The enhanced water quality extends beyond washing applications to improve drinking water, cooking water, and general use water throughout the vehicle, while preventing calcium accumulation in pipes, faucets, shower heads, and appliances that can lead to reduced performance and costly repairs over time.

Space efficiency and organization advantages enable the system to deliver comprehensive water treatment capabilities within the constraints of limited vehicle storage space. The compact design accommodates installation within a single vehicle compartment while maintaining full functionality across both treatment pathways, maximizing the utilization of available space without compromising operational effectiveness. The waterproof containment platform provides organized arrangement of treatment components while protecting surrounding vehicle structures from water spillage or leakage during operation. The multi-level design and integrated storage capabilities enable accommodation of cleaning supplies, accessories, and maintenance items within the same installation space, reducing the need for separate storage areas throughout the vehicle. The slide assembly configuration enhances accessibility for operation and maintenance activities while maintaining secure storage during vehicle movement, providing convenient access without permanent extension into vehicle living or storage areas.

Operational flexibility represents a significant advantage through the system's ability to accommodate various water sources and usage scenarios encountered during travel. The quick-connect hose attachment enables rapid connection to city water systems, campground supplies, or other external water sources without complex setup procedures or specialized tools. The system may operate directly from external water sources while maintaining treated water supplies for internal vehicle use, providing continuous operation capabilities without depleting onboard water reserves. The remote-control functionality eliminates the need for operators to repeatedly return to the system during washing operations, enabling efficient cleaning procedures while maintaining control over system operation from various positions around the vehicle. The dual-pathway design allows selective operation of treatment components based on specific water quality requirements and usage applications, optimizing system performance while conserving treatment capacity for situations where enhanced water quality provides the greatest benefit.

Cost savings and maintenance benefits accumulate over time through reduced dependence on external services and improved vehicle system longevity. The elimination of third-party washing services reduces ongoing operational expenses while providing superior cleaning results compared to many commercial facilities. The prevention of calcium buildup and scale formation in vehicle plumbing systems reduces maintenance requirements and extends the operational life of water heaters, pumps, faucets, and other water-related components that can experience reduced performance or failure when exposed to hard water conditions over extended periods. The spot-free washing capability helps maintain vehicle appearance and finish quality, potentially reducing the need for paint correction, fiberglass repair, or other cosmetic restoration procedures that can result from inadequate cleaning or water spot etching. The system's ability to improve overall water quality for drinking and cooking applications may reduce the need for bottled water purchases or separate filtration systems, providing additional cost savings while enhancing convenience during travel.

System integration and reliability advantages stem from the comprehensive design approach that addresses multiple water treatment requirements within a unified platform. The integrated electrical power configuration enables consistent operation from standard vehicle electrical systems without dependence on engine-driven or manual pumping systems that may provide inconsistent performance or require additional maintenance. The regeneration capabilities of both treatment pathways enable extended operational periods between service intervals, while the modular component arrangement facilitates maintenance and replacement activities when treatment capacity becomes depleted. The corrosion-resistant construction materials and waterproof containment features provide durability under the environmental conditions encountered during vehicle operation, including temperature variations, humidity exposure, and road vibration stresses that can affect system performance over time. The comprehensive valve and control configuration enables system operation across various scenarios while providing protection against backflow, contamination, or other conditions that could compromise water quality or system functionality.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A water system configured for installation in a vehicle, the water system comprising:
a pressure washer;
a de-ionization system configured for de-ionizing water, the de-ionization system in fluid communication with the pressure washer and configured to supply de-ionized water to the pressure washer;
a water softener configured for softening water, the water softener in fluid communication with a water tank installed in the vehicle and configured to supply softened water to the water tank; and
a tee junction in fluid communication with the de-ionization system and the water softener, the tee junction routing an inlet feed of water to each of the de-ionization system and the water softener.

2. The water system of claim 1, further comprising a valve in fluid communication with the tee junction and the water tank, wherein the valve is configured to selectively route water from the inlet feed through the tee junction to the de-ionization system or from the water tank to the de-ionization system.

3. The water system of claim 1, further comprising one or more water filters for filtering the water in the water system.

4. The water system of claim 3, wherein the one or more water filters comprise a first water filter positioned upstream of the tee junction.

5. The water system of claim 4, wherein the one or more water filters further comprise a second water filter positioned downstream of the de-ionization system.

6. The water system of claim 1, wherein the pressure washer is electrically powered and comprises a hose reel configured for holding a pressure washing hose.

7. The water system of claim 6, wherein the hose reel is configured for automatic retraction of the pressure washing hose held thereon.

8. The water system of claim 6, further comprising a remote control system configured to operate the pressure washer.

9. The water system of claim 1, wherein the de-ionization system comprises a dual-bed ion exchange configuration.

10. The water system of claim 1, further comprising a waterproof tray configured to support the pressure washer, the de-ionization system, and the water softener within a single compartment of the vehicle.

11. The water system of claim 10, wherein said tray comprises a slide assembly operatively coupled between the compartment and the tray, the slide assembly configured to permit translational movement of the tray between a retracted position within the compartment and an extended position projecting from the compartment, the slide assembly comprising a slide stop configured to limit travel of the tray between the retracted and extended position.

12. The water system of claim 10, further comprising a mounting system for mounting the pressure washer, de-ionization system, and water softener on the tray.

13. The water system of claim 12, wherein said mounting system, pressure washer, de-ionization system, and water softener are shaped and arranged to fit on the tray having a width in an approximate range of 24 inches to 48 inches and a length in an approximate range of 24 inches to 60 inches.

14. The water system of claim 1, wherein the water softener is in in fluid communication with a water heater installed in the vehicle and configured to supply softened water to the water heater.

15. A water system for a vehicle, the water system comprising:
a pressure washer;
a de-ionization system configured for de-ionizing water, the de-ionization system in fluid communication with the pressure washer and configured to supply de-ionized water to the pressure washer;
a water softener configured for softening water, the water softener in fluid communication with a water tank installed in the vehicle and configured to supply softened water to the water tank; and
a valve in fluid communication with an inlet feed of water and the water tank, the inlet feed of water supplying water to each of the de-ionization system and the water softener through a tee junction, the valve configured to selectively route water from the inlet feed through the tee junction to the de-ionization system or from the water tank to the de-ionization system.

16. The water system of claim 15, wherein the pressure washer comprises a hose reel and a remote control system, the hose reel configured for automatic retraction and the remote-control system configured to enable wireless operation of the pressure washer.

17. The water system of claim 15, further comprising a waterproof tray configured to support the pressure washer, the de-ionization system, and the water softener within a single compartment of the vehicle.

18. The water system of claim 17, further comprising a mounting system for mounting the pressure washer, de-ionization system, and water softener on the tray.

19. A method of installing a water system in a vehicle, the water system comprising a pressure washer, a de-ionization system, and a water softener, the de-ionization system configured for de-ionizing water, the de-ionization system in fluid communication with the pressure washer and configured to supply de-ionized water to the pressure washer, the water softener configured for softening water and supplying softened water to a water tank installed in the vehicle, the method comprising:
installing a mounting system on a tray;
mounting the water system on the tray using the mounting system;
installing the tray in a compartment of the vehicle;
connecting an inlet feed of the water system to a water source;
installing a tee junction in fluid communication with the inlet feed to route water to both the de-ionization system and the water softener;
establishing fluid communication between the de-ionization system and a pressure washer; and
establishing fluid communication between the water softener and a water tank installed in the vehicle.

20. The method of claim 16, further comprising at least one of installing one or more water filters upstream of the tee junction to filter water from the inlet feed before routing the water through the tee junction or installing an additional water filter downstream of the de-ionization system to filter deionized water before supplying the deionized water to the pressure washer.
